(19) United States
(12) Patent Application Publication
(10) Pub. No.: US 2014/0247959 A1
(43) Pub. Date: Sep. 4, 2014

(54) DISPLAY APPARATUS

(71) Applicant: FUNAI ELECTRIC CO., LTD., OSAKA (JP)

(72) Inventors: Takahito YAMANAKA, Osaka (JP); Osamu AOKI, Osaka (JP)

(73) Assignee: FUNAI ELECTRIC CO., LTD., OSAKA (JP)

(21) Appl. No.: 14/186,319

(22) Filed: Feb. 21, 2014

(30) Foreign Application Priority Data
Mar. 1, 2013 (JP) 2013-041114

(51) Int. Cl. H04R 1/02

(52) U.S. Cl. CPC H04R 1/028
USPC 381/388

(57) ABSTRACT

A display apparatus includes: a display panel; a speaker provided behind the display panel; a cover including a front cover component covering an outer peripheral portion of the display panel from the front and a back cover component covering the display panel from behind; and a speaker securing component which secures the speaker to emit sound away from the display panel. The speaker securing component and the back cover component form therebetween a sound guiding space which guides, in a first direction toward a side surface of the display panel, the sound emitted from the speaker and further guides the sound guided in the first direction toward the front. In the sound guiding space, a speaker-facing region of the back cover component intersects with a plane perpendicular to an emission direction of the speaker such that the emission direction points toward the first direction.

### CROSS REFERENCE TO RELATED APPLICATION

The present application is based on and claims priority of Japanese Patent Application No. 2013-041114 filed on Mar. 1, 2013. The entire disclosure of the above-identified application, including the specification, drawings and claims is incorporated herein by reference in its entirety.

### FIELD

The present invention relates to display apparatuses provided with a speaker behind the display panel.

### BACKGROUND

A conventional display module is known in which an oscillating element (speaker) is provided between the back surface of a liquid crystal display panel and a back plate member of the housing in an effort to reduce the size of the display module to roughly the surface area of the display screen of the liquid crystal display panel (Patent Literature (PTL) 1). This display module includes a sound guiding space for emitting the sound generated by the speaker on the viewing side (in other words, the front) of the liquid crystal display panel. The sound guiding space allows the display module to effectively and efficiently emit the sound generated by the speaker toward the front of the liquid crystal display panel even though the speaker is arranged behind the liquid crystal display panel.

### CITATION LIST

### Patent Literature

[PTL 1] Japanese Patent No. 4237748

### SUMMARY

### Technical Problem

However, with the configuration of the display module disclosed in PTL 1, adequately guiding the sound generated by the speaker to the front of the liquid crystal display panel is difficult.

As such, in view of the above problem, the present invention aims to provide a display apparatus capable of effectively and efficiently guiding sound emitted from a speaker arranged behind the display panel to the front of the display panel.

### Solution to Problem

In order to solve the above problem, the display apparatus according to an aspect of the present invention includes a display panel which displays an image on a front surface thereof; a speaker provided on a back surface side of the display panel; a cover including a front cover component which covers at least an outer peripheral portion of the display panel from a front surface side and a back cover component which covers the display panel from the back surface side and is joined to the front cover component; and a speaker securing component which secures the speaker between the display panel and the back cover component such that the speaker faces and emits sound away from the display panel, wherein the speaker securing component and the back cover component form therebetween a sound guiding space which guides, in a first direction toward a side surface side of the display panel, the sound emitted from the speaker and further guides, in a direction toward the front surface side of the display panel, the sound guided in the first direction, and in the sound guiding space, at least a speaker-facing region of the back cover component that faces the speaker intersects with a plane perpendicular to an emission direction of the sound from the speaker such that the emission direction points toward the first direction.

With this, sound emitted from the speaker away from the back of the display panel is guided by the sound guiding space in the first direction toward the side surface side of the display panel and then further guided toward the front of the display panel. Additionally, in the sound guiding space, at least a region of the back cover component facing the speaker—the speaker-facing region—and a plane perpendicular to an emission direction of the sound from the speaker intersect such that the emission direction points toward the first direction.

With this, in the sound guiding space, the emission direction of the sound emitted by the speaker and the speaker-facing region intersect at an obtuse angle on the first direction side. In other words, the sound emitted by the speaker easily reflects off the speaker-facing region toward the first direction. As a result, the sound emitted from the speaker in a direction away from the back of the display panel is easier to guide toward the first direction. Moreover, since the sound effectively and efficiently guided toward the first direction is further guided toward the front by the sound guiding space, the sound emitted from the speaker arranged behind the display panel can be effectively and efficiently guided to the front of the display panel.

Moreover, for example, the speaker-facing region of the back cover component may be parallel to the display panel, and the speaker securing component may hold the speaker such that the plane is oblique to the display panel.

Moreover, for example, the speaker-facing region of the back cover component may be oblique to the display panel, and the speaker securing component may hold the speaker such that the plane is parallel to the display panel.

Moreover, for example, the speaker securing component may include (i) a back surface portion covering at least a portion of a back surface of the display panel and securing the speaker and (ii) a side surface portion formed as an extension of the back surface portion and covering at least a portion of a side surface of the display panel, the back cover component may cover a side of the speaker securing component opposite a side on which the display panel is provided, and at least one of the speaker securing component or the back cover component may include a wall which prevents sound from traveling in a direction other than a sound guiding direction of the sound guiding space.

With this, at least one of the speaker securing component or the back cover component includes a wall which prevents sound from traveling in a direction other than the sound guiding direction of the sound guiding space (in other words, in a direction other than the direction toward the front after the first direction). As a result, in the display apparatus, the sound guiding space is capable of effectively and efficiently guiding the sound emitted therein from the speaker toward the front of the display panel.

Moreover, for example, the wall may include a first wall portion which is provided on the back surface side of the display panel and surrounds the speaker except in the first direction, and a second wall portion which is formed as an extension of the first wall portion on the side surface side of the display panel and extends in an arrangement direction of the display panel and the back cover component.

With this, the first wall portion is provided on the back surface side of the display panel and surrounds the speaker except in the first direction. Moreover, the second wall portion formed as an extension of the first wall portion extends in a direction in which the display panel and the back cover component are arranged. As a result, the first wall portion and the second wall portion can prevent sound from traveling in a direction other than the direction in which the sound guiding space guides the sound.

Moreover, for example, the speaker securing component may be fixed in place by being sandwiched between the display panel and the back cover component at the wall.

This makes it is possible to fix the speaker securing component in a desired position simply by, for example, providing a restrictor for restricting movement of the speaker securing component in a direction perpendicular to the arrangement direction of the display panel and the back cover component. As a result, the speaker securing component can easily be fixed in place without the use of fasteners, such as screws or rivets, or adhesives.

Moreover, the wall functions as a restrictor for preserving a space between the back surface portion as well as the side surface portion of the speaker securing component and the back cover component with the height of the wall. This makes it is possible to easily provide the sound guiding space between the speaker securing component and the back cover component.

Moreover, for example, the speaker securing component and the back cover component may be in close contact at the wall.

This makes it possible to seal all areas of the sound guiding space except for the exit through which sound passing through the sound guiding space exits. As a result, the sound emitted from the speaker can be effectively and efficiently emitted toward the front of the display panel.

Moreover, for example, the speaker securing component and the back cover component may be in close contact at the wall via a cushion.

This makes it possible to seal the portion of the wall formed at the speaker securing component and the back cover component even when there are faults in the shape and size of the speaker securing component and the back cover component at the wall which make it difficult to form a seal. In other words, if there are gaps between the speaker securing component and the back cover component at the wall when the speaker securing component and the back cover component are put together, the cushion fills in those gaps. As a result, all other areas of the sound guiding space except for the exit can be easily sealed to form an enclosed space whereby the sound emitted from the speaker can be effectively and efficiently emitted toward the front of the display panel.

Moreover, for example, the sound guiding space may be wider toward an exit thereof.

This makes it possible to effectively and efficiently emit the sound emitted from the speaker toward the front of the display panel.

Moreover, for example, the front cover component may cover at least the outer peripheral portion of the display panel and a portion of the front cover component may be arranged on an exit side of the sound guiding space, and the portion of the front cover component may be provided with an opening.

This makes it possible to effectively and efficiently emit the sound guided by the sound guiding space on the front side of the display panel even when the front cover component is arranged at the exit of the sound guiding space.

Moreover, for example, the opening may be wider toward a front surface of the front cover component.

Moreover, for example, the display panel may be rectangular, and the front cover component and the speaker securing component may include a restrictor which restricts the speaker securing component from moving in a direction parallel to a side of the front surface of the display panel that is located in the first direction.

This makes it possible to easily fix the speaker securing component in place.

Moreover, for example, the back cover component may be more rigid in a portion forming the sound guiding space than in other portions that do not form the sound guiding space.

With this, at least the portion of the back cover component that forms the sound guiding space is formed from a rigid material. As a result, the sound guiding space is capable of effectively and efficiently guiding the sound emitted into the sound guiding space from the speaker toward the front of the display panel.

### Advantageous Effects

With the present invention, it is possible to effectively and efficiently guide sound emitted from a speaker arranged behind a display panel to the front of the display panel.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1A shows the display apparatus according to the embodiment from the front.

FIG. 1B shows the display apparatus according to the embodiment from the back.

FIG. 2 shows the display apparatus according to the embodiment from the back with the back cover component removed.

FIG. 3 is an exploded perspective view showing the display apparatus according to the embodiment with the back cover component separated therefrom.

FIG. 4 shows a cross section of the display apparatus at the line Iv-Iv shown in FIG. 1A.

FIG. 5 is a perspective view showing the speaker unit portion of the display apparatus according to the embodiment from the back with the back cover component removed.

FIG. 6A is a perspective view showing the restrictor portion of the speaker securing component of the speaker in the display apparatus according to a variation of embodiment from the back with the back cover component removed.

FIG. 6B is a perspective view showing the restrictor portion of the speaker securing component of the speaker in the display apparatus according to a variation of embodiment with the back cover component on.

FIG. 7 is a perspective view showing the speaker portion of display apparatus according to a variation of embodiment with the back cover component removed.

### DESCRIPTION OF EMBODIMENT

Hereinafter, an exemplary embodiment is described in greater detail with reference to the accompanying Drawings. It should be noted the embodiment described below shows a specific example of the present invention. The numerical values, shapes, materials, structural elements, the arrangement and connection of the structural elements etc. shown in the following exemplary embodiment are mere examples, and therefore do not limit the present invention, the scope of which is defined in the appended Claims. As such, among the structural elements in the following exemplary embodiment, structural elements not recited in any one of the independent claims defining the most generic part of the inventive concept are described as structural elements of a preferable embodiment, and are not absolutely necessary to overcome the problem according to the present invention.

### Embodiment

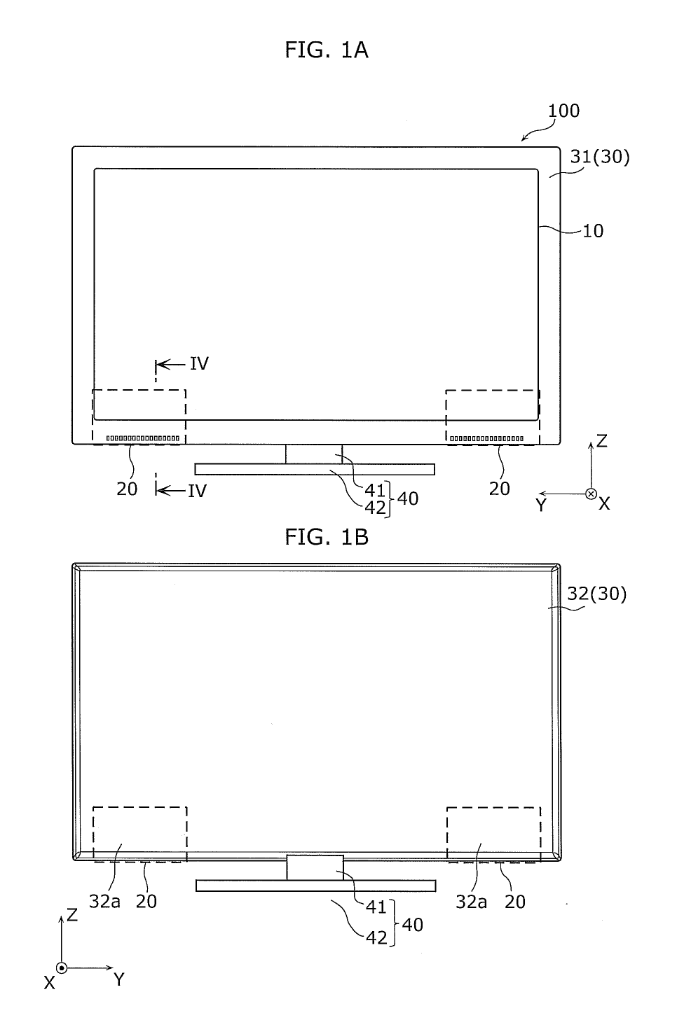

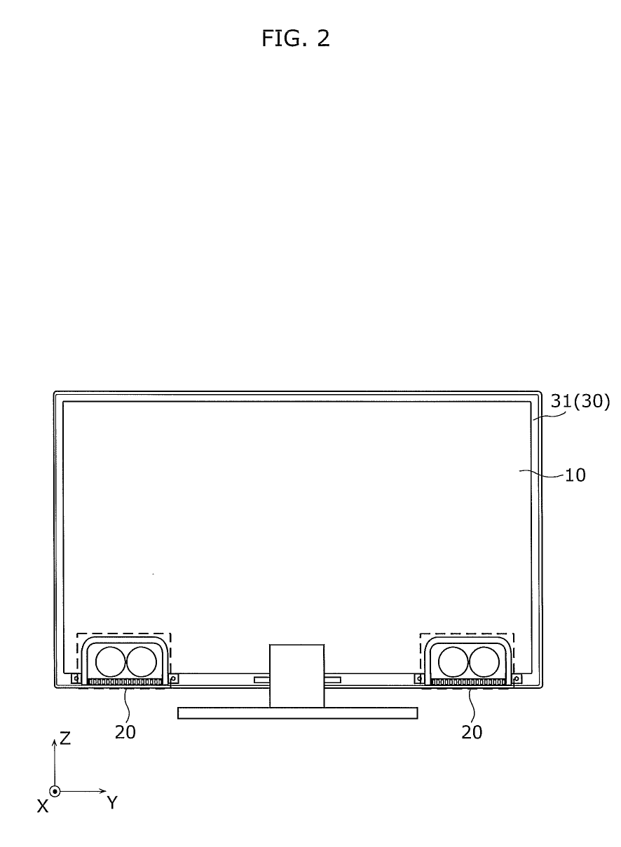

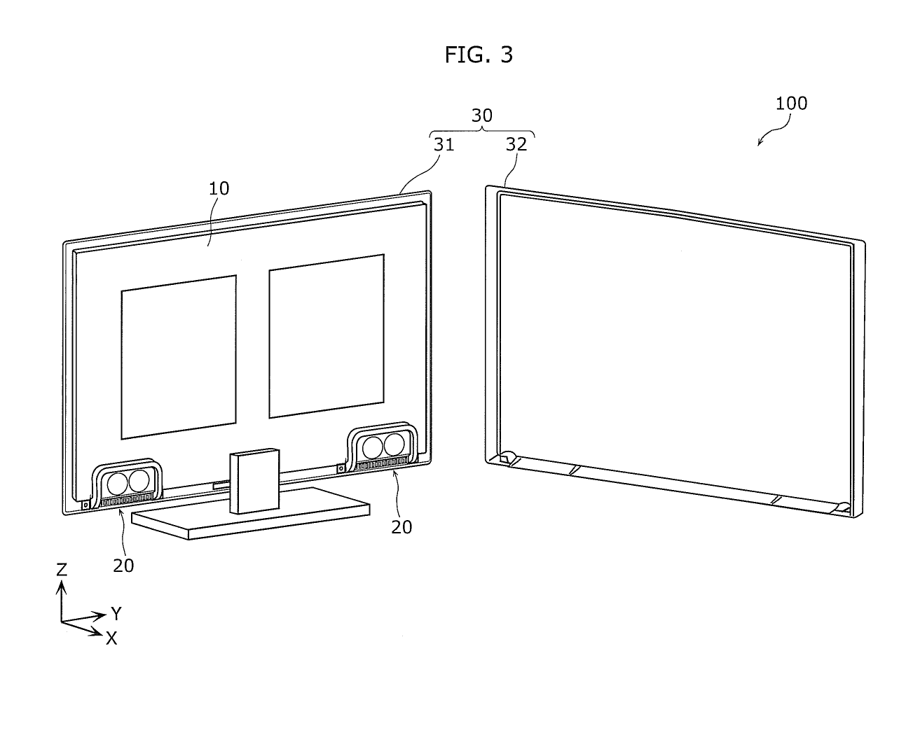

FIG. 1A shows the display apparatus according to the embodiment from the front. FIG. 1B shows the display apparatus according to the embodiment from the back. FIG. 2 shows the display apparatus according to the embodiment from the back with the back cover component removed. FIG. 3 is an exploded view showing the display apparatus according to the embodiment with the back cover component separated therefrom.

The display apparatus 100 is capable of displaying and reproducing inputted images and sounds, and is, for example, a television or a monitor equipped with speakers.

As FIG. 1A, FIG. 1B, FIG. 2, and FIG. 3 show, the display apparatus 100 includes a display panel 10, a speaker unit 20, a cover 30, and a stand 40.

The display panel 10, examples of which include a liquid crystal panel, plasma panel, or organic electroluminescent panel, displays an inputted image on a front surface thereof. It should be noted that the term “inputted image” includes an image inputted from a television tuner which receives broadcast waves. Moreover, the side of the display panel 10 which displays the image is referred to as the front surface side and the opposite side is referred to as the back surface side. The anteroposterior direction is defined as the X axis direction.

The speaker unit 20 is provided in two locations toward the bottom of the display panel 10 (the locations outlined with dashed lines in FIG. 1A, FIG. 1B, and FIG. 2). Moreover, the speaker units 20 are provided between the display panel 10 and a back cover component 32 of the cover 30 (to be described later). It should be noted that regarding the display apparatus 100 according to the embodiment, the arrangement direction of the two speaker units 20 is the horizontal direction with respect to the display apparatus 100, and the horizontal direction is defined as the Y axis direction.

The cover 30 includes a front cover component 31 which covers the outer peripheral portion of the display panel 10 from the front surface side and a back cover component 32 which covers the display panel 10 from the back surface side and is joined to the front cover component 31. The cover 30 houses therein the display panel 10 and the speaker unit 20.

The stand 40 includes: a support member 41 which supports at least one of the display panel 10 or the cover 30; and a plate-shaped base 42 which is connected to the support member 41 and extends in the X and Y axis directions. It should be noted that regarding the display apparatus 100, the direction in which the support member 41 extends is the vertical direction, and the vertical direction is defined as the Z axis direction. Here, the X, Y, and Z axis directions intersect each other orthogonally. It should be noted that the X, Y, and Z axis directions may simply intersect each other, and are not necessarily limited to orthogonal intersections.

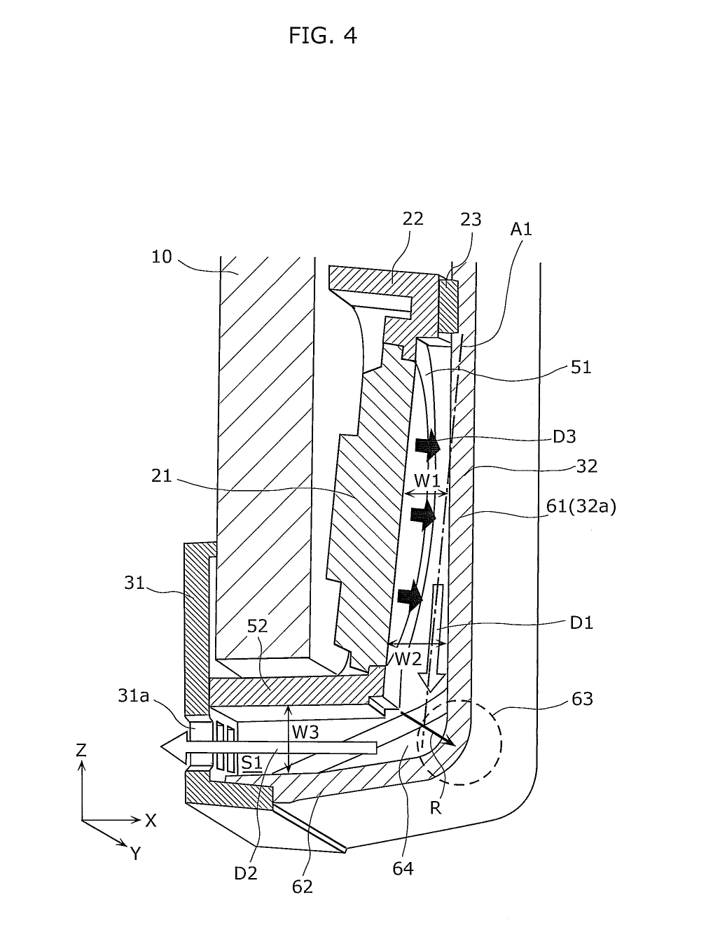

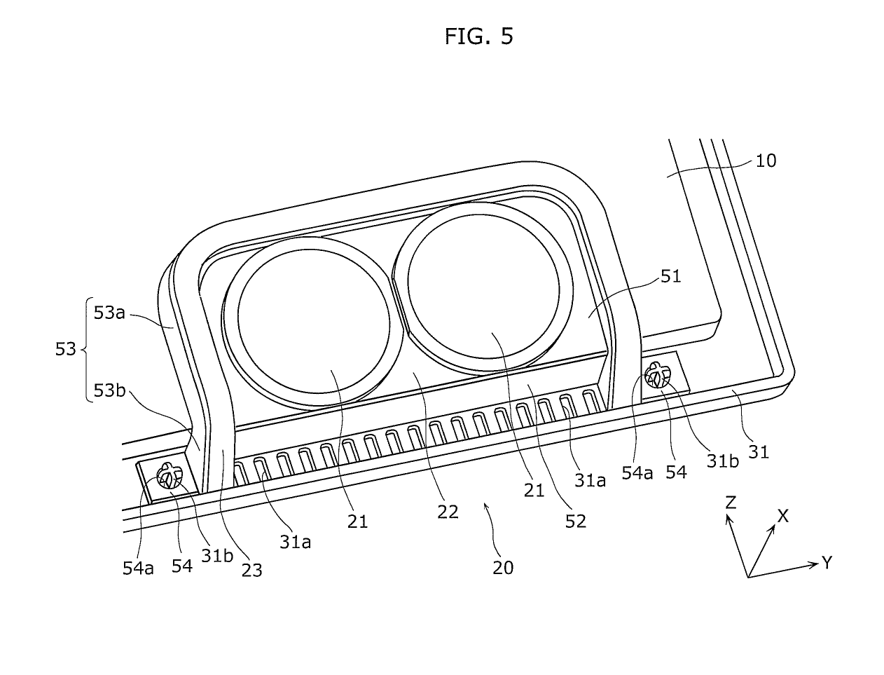

FIG. 4 shows a cross section of the display apparatus at the line Iv-Iv shown in FIG. 1A. FIG. 5 is a perspective view showing the speaker unit portion of the display apparatus according to the embodiment from the back with the back cover component removed.

As FIG. 4 and FIG. 5 show, the speaker unit 20 includes a speaker 21, a speaker securing component 22, and a cushion 23.

The speaker 21 reproduces inputted sound. In the embodiment, two speakers 21 are provided for one speaker unit 20.

The speaker securing component 22 secures the two speakers 21 between the display panel 10 and the back cover component 32 of the cover 30 in such a manner that the two speakers 21 face and emit sound away from the back of the display panel 10. The speaker securing component 22 includes a first back surface portion 51, a first side surface portion 52, a wall 53, and a tab 54

The first back surface portion 51 covers the region shown by the dashed line in FIG. 1A, FIG. 1B, and FIG. 2, which is a portion of the back surface side of the display panel 10. The first back surface portion 51 is the portion of the speaker securing component 22 that secures the two speakers 21.

The first side surface portion 52 is formed as an extension of the first back surface portion 51 and is the portion of the speaker securing component 22 that covers a portion of the side surface side of the display panel 10.

The wall 53 includes a first wall portion 53a and a second wall portion 53b. The first wall portion 53a is provided on the back surface side of the display panel 10 and surrounds the two speakers 21 except in the first direction D1. In other words, the first wall portion 53a is provided partially surrounding the two speakers 21—in three of all four directions. The excluded direction is the first direction D1. It should be noted that the “surrounds the two speakers 21” does not refer to surrounding each of the two speakers 21 individually, but refers to surrounding the two speakers 21 as a whole. The second wall portion 53b is provided on the side surface side of the display panel 10 and formed as an extension of the first wall portion 53a. The second wall portion 53b extends in the alignment direction of the display panel 10 and the back cover component 32 (in other words, the anteroposterior direction).

The cushion 23 is provided between the wall 53 of the speaker securing component 22 and the back cover component 32, and is a sealing member having rubber- or sponge-like elasticity for providing close contact of the speaker securing component 22 and the back cover component 32. In other words, the speaker securing component 22 and the back cover component 32 are in close contact at the wall 53 via the cushion 23. Additionally, the speaker securing component 22 is fixed in place by being sandwiched between the display panel 10 and the back cover component 32 at the wall 53.

The tabs 54 each include a hole 54a and are a flat, plate-shaped members extending in the Y axis direction from both ends of the front portion of the first side portion 52 of the speaker securing component 22. Moreover, the front cover component 31 of the cover 30 is provided with a protrusion 31b protruding in a direction away from the back of the display panel 10. The protrusion 31b is positioned on the front cover component 31 on both sides of the portion contacting the first side surface portion 52 of the speaker securing component 22 in the Y axis direction. The position of the speaker securing component 22 is restricted in the Y axis direction by the protrusion 31b on the front cover component 31 being inserted through the hole 54a in the tab 54. In other words, the tab 54 and the protrusion 31b are provided on the speaker securing component 22 and the front cover component 31 and collectively form a restrictor which restricts the speaker securing component 22 from moving, with respect to the front cover component 31, in a direction parallel to a side of the display surface (front surface) of the display panel 10 located in the first direction D1 (in other words, located in the Y axis direction).

The speaker securing component 22 and the back cover component 32, as FIG. 4 shows, form the sound guiding space S1. The sound guiding space S1 is formed between the speaker securing component 22 and the back cover component 32, and guides sound emitted from the speaker 21 in the first direction D1 (downward) which is a direction toward a side of to the display panel 10, and further guides the sound guided in the first direction D1 in a second direction D2 (forward) which is a direction away from the front of the display panel 10. More specifically, the sound guiding space S1 is formed by the back cover component 32 covering a side of the speaker securing component 22 that is opposite the side the display panel 10 is located.

It should be noted that the back cover component 32 includes a second back surface portion 61, a second side surface portion 62, and a curved portion 63. The second back surface portion 61 is the portion of the back cover component 32 that faces the first back surface portion 51 of the speaker securing component 22. In other words, the second back surface portion 61 is a speaker-facing region 32a which covers the back of the speaker unit 20. The second side surface portion 62 is the portion of the back cover component 32 that faces the first side surface portion 52 of the speaker securing component 22. In other words, the second side surface portion 62 covers the speaker unit 20 from below. The curved portion 63 is the portion of the back cover component 32 that connects the second back surface portion 61 and the second side surface portion 62 with a curve having a radius of curvature R. The back cover component 32 further includes, in the second side surface portion 62, a wall 64 which protrudes from the second side surface portion 62 toward the speaker securing component 22 and is in close contact with the second wall portion 53b of the speaker securing component 22.

That is to say, the sound guiding space S1 is formed by (i) the back cover component 32 covering the side of the speaker securing component 22 that is opposite the side the display panel 10 is located and (ii) the above-described first wall portion 53a, second wall portion 53b, and wall 64 being formed between the back cover component 32 and the speaker securing component 22. In other words, the sound guiding space S1 is a space formed between the speaker securing component 22 and the back cover component 32 and having a portion sealed by the first wall portion 53a, the second wall portion 53b, and the wall 64, the sealed portion being the region surrounding the speaker 21 except for the portion in the direction in which the sound emitted from the speaker 21 is guided.

Moreover, the second back surface portion 61 of the back cover component 32 (the speaker-facing region 32a) is parallel to the display panel 10. The speaker securing component 22 secures the speaker 21 so that the plane A1 is oblique to the display panel 10. In other words, in the sound guiding space S1, the back cover component 32 includes a speaker-facing region 32a that faces the speaker 21 and intersects with a plane A1 perpendicular to the emission direction D3 of the sound from the speaker 21 such that the emission direction points toward the first direction.

Additionally, the sound guiding space S1 is wider toward the exit thereof. More specifically, the sound guiding space S1 is formed such that the gap W2 is bigger than the gap W1, as FIG. 4 shows. The gap W1 is a gap in the region where the speaker 21 is provided, between the first back surface portion 51 of the speaker securing component 22 and the back cover component 32. The gap W2 is a gap between the back cover component 32 and a portion in the vicinity of the boundary of the first back surface portion 51 and the first side surface portion 52 of the speaker securing component 22 near the exit of the sound guiding space S1. Furthermore, the sound guiding space S1 is formed such that the gap W3 is bigger than the gap W2, as FIG. 4 shows. The gap W3 is a gap between the first side surface portion 52 of the speaker securing component 22 and the back cover component 32 near the exit of the sound guiding space S1. In other words, the distance between the first back surface portion 51 and the second back surface portion 61 increases in the first direction D1. Additionally, the distance between the first side surface portion 52 and the second side surface portion 62 increases in the second direction D2.

The front cover component 31 covers an outer peripheral portion of the display panel 10 and a portion of the front cover component 31 is arranged on the exit side of the sound guiding space S1. A plurality of openings 31a are formed in the portion of the front cover component 31 arranged on the exit side of the sound guiding space S1. It should be noted that the openings 31a are not required to be provided in plurality; a single opening 31a may be provided.

With the display apparatus 100 according to the embodiment, sound emitted away from the back of the display panel 10 by the speaker 21 is guided by the sound guiding space S1 in the first direction D1 toward a side surface side the display panel 10. The sound guided in the first direction D1 by the sound guiding space S1 is then further guided in the second direction D2 toward the front of the display panel 10. In other words, in the sound guiding space S1, at least a speaker-facing region 32a of the back cover component 32 that faces the speaker 21 intersects with a plane A1 perpendicular to the emission direction D3 of the sound from the speaker 21 such that the emission direction D3 points toward the first direction D1.

With this, in the sound guiding space S1, the emission direction D3 of the sound emitted by the speaker 21 and the region of the back component facing the speaker (speaker-facing region 32a) intersect at an obtuse angle on the first direction D1 side. In other words, the sound emitted by the speaker 21 easily reflects off the speaker-facing region 32a toward the first direction D1. As a result, the sound emitted from the speaker 21 in a direction away from the back of the display panel 10 is easier to guide toward the first direction D1. Moreover, since the sound guiding space S1 guides the sound effectively and efficiently guided toward the first direction D1 further toward the second direction D2, the sound emitted from the speaker 21 in a direction away from the back of the display panel 10 can be effectively and efficiently emitted toward the front of the display panel 10.

Moreover, since the display apparatus 100 is provided with the sound guiding space S1 having the above-described configuration, it is possible to arrange the speaker 21 not on the front of the display panel 10 but on the back and still effectively and efficiently guide sound emitted from the speaker 21 to the front of the display panel 10. As a result, with the display apparatus 100, it is possible to eliminate the need for spaces on the sides of the display panel 10 for the speakers 21. This in turn allows for the size of the display apparatus 100 when viewing the display panel 10 from the X axis direction to be smaller.

Moreover, with the display apparatus 100 according to the embodiment, walls 53 and 64, which prevent sound from traveling in any other direction than the first direction D1 and the second direction D2 which are the directions in which the sound guiding space guides the sound, are provided between the speaker securing component 22 and the back cover component 32. As a result, in the display apparatus 100, the sound guiding space S1 is capable of effectively and efficiently guiding the sound emitted therein from the speaker 21 toward the front of the display panel.

Moreover, with the display apparatus 100 according to the embodiment, the first wall portion 53a is provided on the back surface side of the display panel 10 surrounding the speaker 21 except for the portion in the first direction D1 toward the side surface side of the display panel 10. Moreover, the second wall portion 53b formed as an extension of the first wall portion 53a extends in a direction in which the display panel 10 and the back cover component 32 are arranged (the X axis direction). As a result, the first wall portion 53a and the second wall portion 53b can prevent sound from traveling in a direction other than the first direction D1 and the second direction D2, which are the directions in which the sound guiding space S1 guides the sound.

Additionally, with the display apparatus 100 according to the embodiment, the speaker securing component 22 is fixed in place by being sandwiched between the display panel 10 and the back cover component 32 at the walls 53 and 64. This makes it is possible to fix the speaker securing component 22 in a desired position simply by, for example, providing the restrictor for restricting movement of the speaker securing component 22 in a direction (Y or Z axis direction) perpendicular to the arrangement direction (X axis direction) of the display panel 10 and the back cover component 32. As a result, the speaker securing component 22 can easily be fixed in place without the use of fasteners, such as screws or rivets, or adhesives.

Moreover, with the display apparatus 100 according to the embodiment, the walls 53 and 64 function as restrictors for preserving a space between the first back surface portion 51 as well as the first side surface portion 52 of the speaker securing component 22 and the back cover component 32 with the height of the walls 53 and 64. This makes it is possible to easily provide the sound guiding space S1 between the speaker securing component 22 and the back cover component 32.

Moreover, with the display apparatus 100 according to the embodiment, the speaker securing component 22 and the back cover component 32 are in close contact at the walls 53 and 64. This makes it possible to seal all other areas of the sound guiding space S1 except for the exit through which sound passing through the sound guiding space S1 exits. As a result, the sound emitted from the speaker 21 can be effectively and efficiently emitted toward the front of the display panel 10.

Moreover, with the display apparatus 100 according to the embodiment, the speaker securing component 22 and the back cover component 32 are in close contact at the walls 53 and 64 via the cushion 23. This makes it possible to seal the portion of the walls 53 and 64 formed at the speaker securing component 22 and the back cover component 32 even when there are discrepancies in the shape and size of the speaker securing component 22 which make the back cover component 32 at the walls 53 and 64 difficult to form a seal. As a result, all areas of the sound guiding space S1 except for the exit can be easily sealed to form an enclosed space and the sound emitted from the speaker 21 can be effectively and efficiently emitted toward the front of the display panel 10.

The display apparatus has hereinbefore been described according to the embodiment of the present invention, but the present invention is not limited to this embodiment.

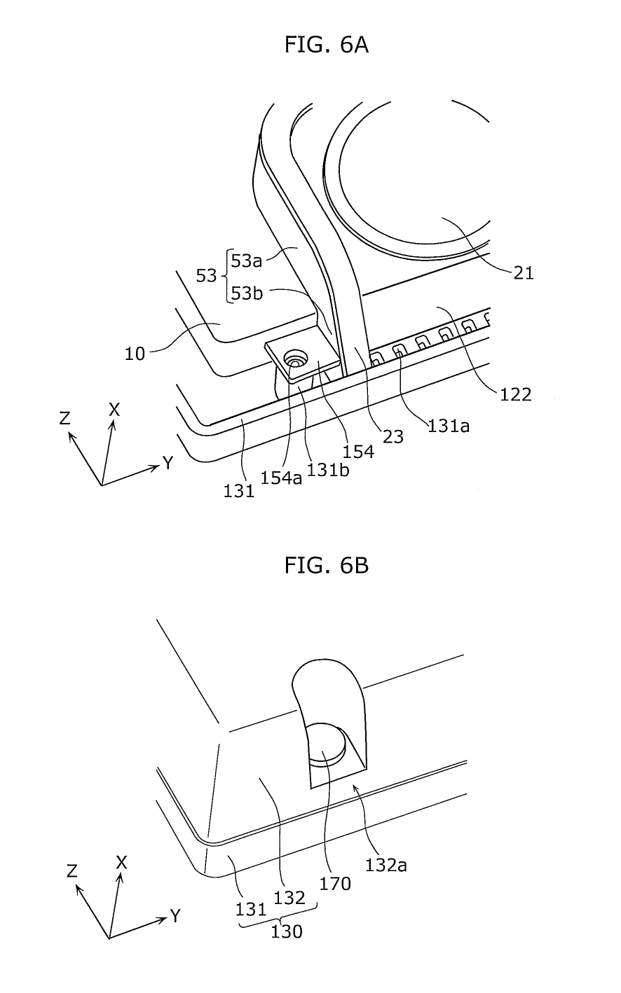

With the display apparatus 100 according to the above embodiment, putting together the protrusion 31b provided on the front cover component 31 and the tab 54 of the speaker securing component 22 provided with the hole 54a restricts, as the restrictor, the position of the speaker securing component 22 in the Y axis direction. However, the present invention is not limited to this configuration. A variation of the restrictor will be described using FIG. 6A and FIG. 6B. FIG. 6A is a perspective view showing the restrictor portion of the speaker securing component of the speaker in the display apparatus according to a variation of embodiment with the back cover component removed. FIG. 6B is a perspective view showing the restrictor portion of the speaker securing component of the speaker in the display apparatus according to a variation of embodiment with the back cover component on.

For example, as FIG. 6A shows, a front cover component 131 is provided with a cylindrical boss 131b for fastening with a screw 170 (see FIG. 6B), and a speaker securing component 122 is provided with a tab 154 having a hole 154a at a position which contacts the end surface of the boss 131b. Additionally, as FIG. 6B shows, a back cover component 132 is joined to the front cover component 131 by passing the screw 170 for fastening the back cover component 132 of a cover 130 through the hole 154a provided in the tab 154 of the speaker securing component 122 and driving it into the boss 131b. The speaker securing component 122 is also fixed into place as a result of the front cover component 131 and the back cover component 132 being joined. It should be noted that the back cover component 132 is provided with a recess 132a to accommodate the head of the screw 170. As this shows, the boss 131b and the tab 154 may function as the restrictor by providing the front cover component 131 with the boss 131b and providing the tab 154, which includes the hole 154a for fastening the screw 170 and the boss 131b, on the speaker securing component 122.

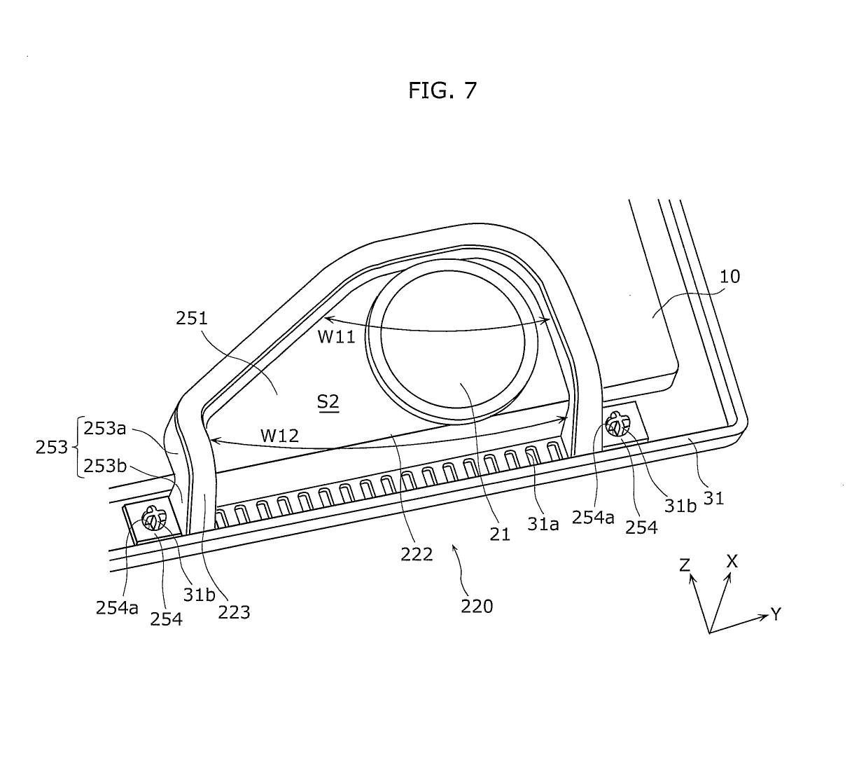

In the display apparatus 100 according to the above embodiment, two speakers 21 are provided for one speaker unit 20, but the present invention is not limited thereto. For example, a speaker unit 220 with a single speaker 21 may be used, as FIG. 7 shows. It should be noted that in this case, as FIG. 7 shows, regarding a speaker securing component 222, the gap W12, which is a gap in the Y axis direction toward the exit of the sound guiding space and further from the speaker 21, is bigger than the gap W11, which is a gap in the Y axis direction closer to the speaker 21. The gap W11 and the gap W12 are gaps in the Y axis direction between a first wall portion 253a formed along the perimeter of a first back surface portion 251 covering a portion of the back surface side of the display panel 10. In this way, the width of the sound guiding space S2 in the Y axis direction is wider toward the exit thereof. In other words, the design of how the width of sound guiding space is wider toward the exit is not limited to a single one of the X, Y, or Z axis directions. For example, the cross sectional area of the sound guiding path denoted by the white arrows in FIG. 4 may be wider toward the exit of the sound guiding space, making it possible to even more effectively and efficiently emit the sound generated by the speaker 21 out of the exit of the sound guiding space (in other words, toward the front of the display apparatus 100). Moreover, the design of the sound guiding space S2, whose width widens in the Y axis direction, is not limited to the example of the speaker unit 220 having only a single speaker 21. This design can also be applied to a speaker unit having a plurality of the speakers 21. It should be noted that when a plurality of the speakers 21 are provided, it is preferable that the length of the sound guiding path in the sound guiding space is equal for each of the speakers 21 provided. By providing a plurality of the speakers 21 in this manner, it is possible to evenly guide the sound generated by the plurality of speakers 21 to the front of the display apparatus 100 without generating a delay in the sound. Moreover, similar to the speaker securing component 22 of the display apparatus 100 according to the embodiment, the speaker securing component 222 is provided with a wall 253 that includes a first wall portion 253a and a second wall portion 253b formed as an extension of the first wall portion 253a. Additionally, a cushion 223 is provided at the end portion of the back surface side of the wall 253. Furthermore, similar to the speaker securing component 22 of the display apparatus 100 according to the embodiment, the speaker securing component 222 is provided with a tab 254 which includes a hole 254a for restricting positionally restricting the speaker securing component 222. The position of the speaker securing component 222 is restricted in the Y axis direction by the protrusion 31b on the front cover component 31 being inserted through the hole 254a in the tab 254.

Moreover, in the display apparatus 100 according to the above embodiment, the second back surface portion 61 of the back cover component 32 (the speaker-facing region 32a) is parallel to the display panel 10, and the speaker securing component 22 holds the speaker 21 such that the plane A1 is oblique to the display panel 10. With the display apparatus 100 having this sort of embodiment, in the sound guiding space S1, the speaker-facing region 32a and the plane A1 intersect such that the emission direction D3 points toward the first direction D1, but the present invention is not limited thereto.

For example, the speaker-facing region of the back cover component and the plane may be made to intersect such that the emission direction D3 points toward the first direction D1 by making the speaker-facing region of the back cover component oblique to the display panel and the speaker securing component hold the speaker such that the plane is parallel to the display panel. Moreover, in the above two configurations, the speaker-facing region 32a of the back cover component 32 or the plane A1 are made to be oblique to the display panel, but the present invention is not limited to these examples. For example, in the sound guiding space, as long as the speaker-facing region of the back cover component and the plane A1 intersect such that the emission direction D3 points toward the first direction D1, the speaker-facing region 32a or the plane A1 may be made to be not parallel with the display panel.

Moreover, assuming the speaker is secured such that the plane A1 is parallel to the display panel, the back cover component may be configured to incline such that the distance therefrom to the plane A1 increases in all directions parallel to the display panel. In this case, the first back surface portion of the speaker securing component covers the whole back surface side of the display panel, and the first side surface portion of the speaker securing component covers the whole side surface side of the display panel. In other words, the sound guiding space is formed across the entire back surface side and entire side surface side of the display panel.

Moreover, in the display apparatus 100 according to the above embodiment, the speaker unit 20 is arranged toward the bottom of the display panel 10 and the sound guiding space guides the sound emitted from the speaker 21 downward as the first direction D1 toward the side surface side of the display panel 10, but the present invention is not limited to this example. For example, the speaker unit 20 may be arranged toward the left side, toward the right side, or toward the top of the display panel 10 of the display apparatus 100, and the first direction D1 in which the sound guiding space guides the sound emitted from the speaker 21 may include the direction toward the left side, the direction toward the right side, and the direction toward the top of the display panel 10. Moreover, as long as the sound guiding space is formed to guide sound to a side surface side of the display panel 10, the speaker 21 of the speaker unit 20 is not required to be arranged toward an edge of the display panel 10, but rather may be arranged near the center of the display panel 10.

Moreover, in the display apparatus 100 according to the above embodiment, the sound guiding space S1 is sealed as a result of the back cover component 32 and the speaker securing component 22 being in close contact due to the provision of the cushion 23, but provision of the cushion 23 is not required if adequate contact can be made with the back cover component 32 and the speaker securing component 22 alone.

Moreover, in the display apparatus 100 according to the above embodiment, the speaker securing component 22 and the back cover component 32 are each provided with the wall 53 and the wall 64, but the present invention is not limited to this example. For example, either the speaker securing component 22 or the back cover component 32 may be provided with a wall that prevents sound from traveling in a direction other than the direction in which the sound guiding space guides the sound.

Moreover, in the display apparatus 100 according to the above embodiment, although not specifically stated, the opening 31a provided in the front cover component 31 may be configured such that the cross-sectional area thereof in the y-z plane increases toward the front. Forming the opening 31a to have this kind of shape makes it possible to effectively and efficiently emit the sound guided by the sound guiding space toward the front of the display panel even when a portion of the front cover component 31 is arranged at the exit of the sound guiding space, similar to the display apparatus 100 according to the embodiment.

Moreover, in the display apparatus 100 according to the above embodiment, a portion of the front cover component 31 is arranged at the exit of the sound guiding space S1, but the present invention is not limited to this example. For example, the front cover component may be configured such that a portion thereof is not arranged at the exit of the sound guiding space. More specifically, the portion of the front cover component arranged at the exit of the sound guiding space may be provided with an opening large enough to accommodate the entire exit of the sound guiding space. Additionally, the portion of the front cover component arranged at the exit of the sound guiding space may be provided with cutout portions so as not to block the sound guiding space exit. In this way, by configuring the front cover component such that a portion thereof is not arranged at the exit of the sound guiding space, since there is nothing to hinder the sound exiting the sound guiding space, it is possible to even more effectively and efficiently emit sound from the sound guiding space toward the front of the display apparatus.

Moreover, in the display apparatus 100 according to the above embodiment, although not specifically stated, the second back surface portion 61, the second side surface portion 62, and the curved portion 63 of the back cover component 32 which form the sound guiding space S1 may be configured to be more rigid than other portions of the back cover component 32. Specifically, in order to make these regions more rigid, they may be (i) made to be more thick, (ii) provided with ribs, (iii), adhered with a metal sheet, (iv) or made of a material that is highly rigid (for example metal, carbon, etc.), for example. It should be noted that in the case of (iii) and (iv), the material for the other portions of the back cover component 32 is a material less rigid than a composite containing a lot of metal, for instance. For example, resin is a possibility. As a result, since at least the portion of the back cover component that forms the sound guiding space is formed as a rigid member, the sound guiding space is capable of effectively and efficiently guiding the sound emitted into the sound guiding space from the speaker toward the front of the display panel.

Moreover, in the display apparatus 100 according to the above embodiment, the front cover component 31 covers only the outer peripheral portion of the display panel 10 from the front, but the front cover component 31 may cover the whole display surface of the display panel 10. In this case, it is conceivable that the front cover component can be configured from a transparent member, such as glass.

Furthermore, the above embodiment and the above variations may be arbitrarily combined.

Although only some exemplary embodiments of the present invention, including the embodiment and its variations, have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

The present invention is applicable as a display apparatus, such as a television or monitor, which effectively and efficiently guides sound emitted from a speaker arranged behind a display panel to the front of the display panel.

1. A display apparatus comprising:
a display panel which displays an image on a front surface thereof;
a speaker provided on a back surface side of the display panel;
a cover including a front cover component which covers at least an outer peripheral portion of the display panel from a front surface side and a back cover component which covers the display panel from the back surface side and is joined to the front cover component; and
a speaker securing component which secures the speaker between the display panel and the back cover component such that the speaker faces and emits sound away from the display panel,
wherein the speaker securing component and the back cover component form therebetween a sound guiding space which guides, in a first direction toward a side surface side of the display panel, the sound emitted from the speaker and further guides, in a direction toward the front surface side of the display panel, the sound guided in the first direction, and
in the sound guiding space, at least a speaker-facing region of the back cover component that faces the speaker intersects with a plane perpendicular to an emission direction of the sound from the speaker such that the emission direction points toward the first direction.

2. The display apparatus according to claim 1,
wherein the speaker-facing region of the back cover component is parallel to the display panel, and
the speaker securing component holds the speaker such that the plane is oblique to the display panel.

3. The display apparatus according to claim 1,
wherein the speaker-facing region of the back cover component is oblique to the display panel, and
the speaker securing component holds the speaker such that the plane is parallel to the display panel.

4. The display apparatus according to claim 1,
wherein the speaker securing component includes (i) a back surface portion covering at least a portion of a back surface of the display panel and securing the speaker and (ii) a side surface portion formed as an extension of the back surface portion and covering at least a portion of a side surface of the display panel,
the back cover component covers a side of the speaker securing component opposite a side on which the display panel is provided, and
at least one of the speaker securing component or the back cover component includes a wall which prevents sound from traveling in a direction other than a sound guiding direction of the sound guiding space.

5. The display apparatus according to claim 4,
wherein the wall includes a first wall portion which is provided on the back surface side of the display panel and surrounds the speaker except in the first direction, and a second wall portion which is formed as an extension of the first wall portion on the side surface side of the display panel and extends in an arrangement direction of the display panel and the back cover component.

6. The display apparatus according to claim 4,
wherein the speaker securing component is fixed in place by being sandwiched between the display panel and the back cover component at the wall.

7. The display apparatus according to claim 4,
wherein the speaker securing component and the back cover component are in close contact at the wall.

8. The display apparatus according to claim 7,
wherein the speaker securing component and the back cover component are in close contact at the wall via a cushion.

9. The display apparatus according to claim 1,
wherein the sound guiding space is wider toward an exit thereof.

10. The display apparatus according to claim 1,
wherein the front cover component covers at least the outer peripheral portion of the display panel and a portion of the front cover component is arranged on an exit side of the sound guiding space, and
the portion of the front cover component is provided with an opening.

11. The display apparatus according to claim 10,
wherein the opening is wider toward a front surface of the front cover component.

12. The display apparatus according to claim 10,
wherein the display panel is rectangular, and
the front cover component and the speaker securing component include a restrictor which restricts the speaker securing component from moving in a direction parallel to a side of the front surface of the display panel that is located in the first direction.

13. The display apparatus according to claim 1,
wherein the back cover component is more rigid in a portion forming the sound guiding space than in other portions that do not form the sound guiding space.
